(19) United States
(12) Patent Application Publication
(10) Pub. No.: US 2010/0110102 A1
(43) Pub. Date: May 6, 2010

(54) Methods of and apparatus for processing computer graphics

(75) Inventors: Jørn Nystad, Trondheim (NO); Frode Heggelund, Trondheim (NO)

Correspondence Address: NIXON & VANDERHYE P.C., 901 N. Glebe Road, 11th Floor, Arlington, VA, 22203-1808, US

(73) Assignee: ARM LIMITED, Cambridge (GB)

(21) Appl. No.: 12/588,666

(22) Filed: Oct. 22, 2009

(30) Foreign Application Priority Data
Oct. 24, 2008 (GB) 0819570.3

(51) Int. Cl. G09G 5/00

(52) U.S. Cl. 345/611

(57) ABSTRACT

In a graphics processing system, when a 16× sampling mask is used for sampling the image to be displayed, fragments are generated and rendered to generate rendered fragment data for each covered sampling position. However, the 16× sampling mask (81, 84, 86, 89) can be divided into a two-level hierarchy for the purpose of associating its sampling points with fragments that are to be rendered, namely a first level in which a fragment (82, 85, 88) is associated with all 16 sampling points of the 16× sampling mask, and a second level in which a fragment (91, 92) is only associated with four sampling points of the 16× sampling mask.

The present invention relates to the processing of computer graphics, and in particular to a method of and an apparatus for carrying out anti-aliasing when processing computer graphics.

The present invention will be described with particular reference to the processing of three dimensional graphics, although as will be appreciated by those skilled in the art, it is equally applicable to the processing of two-dimensional graphics as well.

As is known in the art, 3D graphics processing is normally carried out by first dividing a scene to be displayed into a number of similar basic components (so-called “primitives”) to allow the 3D graphics processing operations to be more easily carried out. These “primitives” are usually in the form of simple polygons, such as triangles.

The primitives for a scene to be displayed are usually generated by the applications program interface for the graphics processing system, using the graphics drawing instructions (requests) received from the application (e.g. game) that requires the display of the graphics.

Each primitive is at this stage usually defined by and represented as a set of vertices. Each vertex for a primitive has associated with it a set of data (such as position, colour, texture and other attributes data) representing the vertex. This data is then used, e.g., when rasterising and rendering the vertex (the primitive(s) to which the vertex relates) for display.

Once primitives for a scene and their vertices have been generated and defined, they can be processed by the graphics processing system, in order, e.g., to display the scene.

This process basically involves determining which sampling points of an array of sampling points covering the scene area to be processed are covered by a primitive, and then determining the appearance each sampling point should have (e.g. in terms of its colour, etc.) to represent the primitive at that sampling point. These processes are commonly referred to as rasterising and rendering, respectively.

The rasterising process determines the sample positions that should be used for a primitive (i.e. the (x, y) positions of the sample points to be used to represent the primitive in the scene to be displayed). This is typically done using the positions of the vertices of a primitive.

The rendering process then derives the data, such as red, green and blue (RGB) colour values and an “Alpha” (transparency) value, necessary to display the primitive at the sample points (i.e. “shades” each sample point). This can involve, as is known in the art, applying textures, blending sample point data values, etc.

(In 3D graphics literature, the term “rasterisation” is sometimes used to mean both primitive conversion to sample positions and rendering. However, herein “rasterisation” will be used to refer to converting primitive data to sampling point addresses only.)

These processes are typically carried out by “representing” the sampling points as discrete graphical entities usually referred to as “fragments” on which the graphics processing operations (such as rendering) are carried out. Each sampling point will, in effect, be represented by a fragment that will be used to render the primitive at the sampling point in question. The “fragments” are the graphical entities that pass through the rendering process (the rendering pipeline).

(A “fragment” is therefore effectively (has associated with it) a set of primitive data as interpolated to a given screen space sample point of a primitive. It may also include per-primitive and other state data that is required to shade the primitive at the sample point (fragment position) in question. Each graphics fragment can reasonably be thought of as being effectively equivalent to a “pixel” of the scene as it is processed).

Each graphics “fragment” may correspond to a single pixel (picture element) in the final display (since as the pixels are the singularities in the final display, there may be a one-to-one mapping between the “fragments” the graphics processor operates on (renders) and the pixels of the display). However, it can be the case that there is not a one-to-one correspondence between a fragment and a display pixel, for example where particular forms of post-processing, such as down-scaling, are carried out on the rendered image prior to displaying the final image.

One problem that is encountered when processing graphics for display (when displaying computer generated images) is that the displayed image is quantised into the discrete pixel locations of the display, e.g. monitor or printer, being used. This limits the resolution of the image that is displayed and can produce unwanted visual artifacts, for example, where the resolution of the output display device is not high enough to display smooth lines. These effects are commonly referred to as “aliasing”.

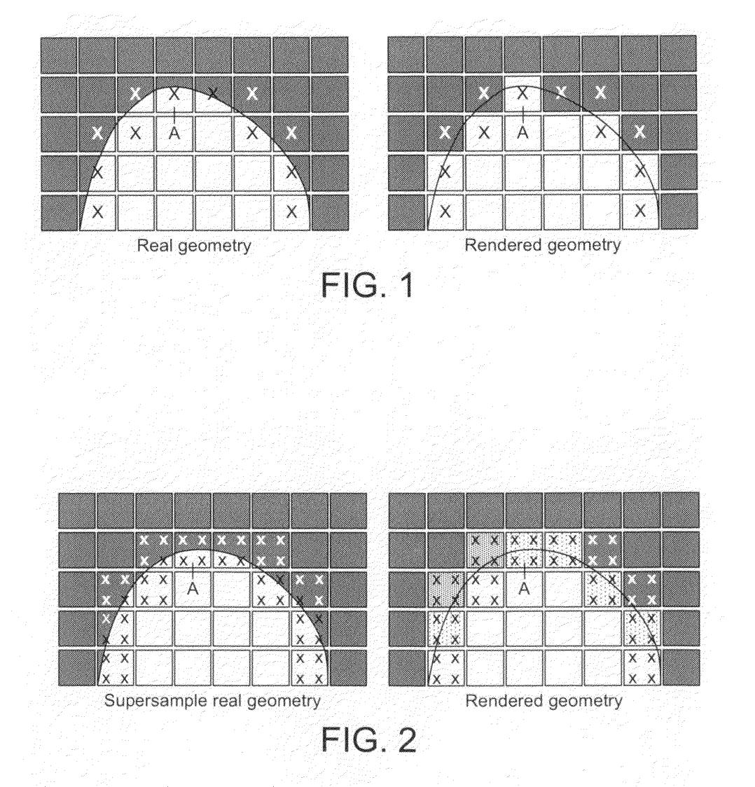

FIG. 1 illustrates such aliasing effects. The lefthand side of FIG. 1 shows the image to be drawn, and the righthand side shows the actual image that is displayed. As can be seen, the desired smooth curve of the white object in fact has a jagged appearance on the display. This is aliasing. (In FIG. 1, each square represents a pixel of the display, and the crosses represent the points at each (x, y) pixel location for which the colour value for that pixel location is determined (sampled). For example, the pixel A in FIG. 1 is drawn as all white, because the colour sampling point for that pixel location falls within the white object. It should be noted that in FIG. 1 only sample crosses on the pixels of interest are shown, although in practice all pixels will be sampled.)

All aliasing artifacts that could be visible to the naked eye could be removed by using a sufficiently high resolution display. However, the resolution of electronic displays and printers is typically limited, and so many graphics processing systems use other techniques to try to remove or reduce the effects of aliasing. Such techniques are typically referred to as anti-aliasing techniques.

One known anti-aliasing technique is referred to as supersampling or oversampling.

In such an arrangement, there are plural sampling points (positions) per pixel of the final display, and a separate colour sample is taken for each (covered) individual sampling point (e.g. by rendering each sampling point as a separate fragment). The effect of this is that a different colour sample is taken for each sampling point of a display pixel that is covered by a primitive during the rendering process.

This means that plural colour samples are taken for each pixel of the display (one for each sampling point for the pixel, since a separate colour value is rendered for each sampling point). These plural colour samples are then combined into a single colour for the pixel when the pixel is displayed. This has the effect of smoothing or averaging the colour values from the original image at the pixel location in question.

FIG. 2 illustrates the supersampling process. In the example shown in FIG. 2, four sample points are determined for each pixel in the display and separate colour samples are taken for each sample point during the rendering process. (Each such sample can accordingly effectively be viewed as a “sub-pixel”, with each pixel in the display being made up of four such sub-pixels.) The four colour value samples (sub-pixels) for a given pixel are then combined (downfiltered) such that the final colour that is used for the pixel in the display is an appropriate average (blend) of the colours of the four colour samples taken for the pixel.

This has the effect of smoothing the image that is displayed, and, e.g., reduces the prominence of aliasing artifacts by surrounding them with intermediate shades of colour. This can be seen in FIG. 2, where the pixel A now has two “white” samples and two “black” samples and so is set to 50% “white” in the displayed image. In this way, the pixels around the edges of the white object are blurred to produce a smoother edge, based on, e.g., how many samples are found to fall on each side of the edge.

Supersampling in effect processes the screen image at a much higher resolution than will actually be used for the display, and then scales and filters (down samples) the processed image to the final resolution before it is displayed. This has the effect of providing an improved image with reduced aliasing artifacts, but requires greater processing power and/or time, since the graphics processing system must in effect process as many fragments as there are samples (such that, e.g., for 4× supersampling (i.e. where 4 samples are taken for each display pixel), the processing requirements will be four times greater than if there was no supersampling).

Other anti-aliasing techniques have therefore been proposed that, while still providing some improvement in image quality, have less processing requirements than full supersampling.

One common such technique is referred to as “multisampling”.

In the case of multisampling, multiple sampling points are again tested for each display pixel to determine whether a given primitive covers the sampling points or not when the image is rasterised into fragments (at the rasterisation stage). Thus the sampling point coverage of a primitive in a multisampling system is determined in a similar fashion to a “supersampling” system (and so the positions of the outer geometric edges of the primitives are still effectively “supersampled” (oversampled) in a multisampling system).

However, in the rendering process of a multisampling system, all the sampling points for a given display pixel that are covered by the primitive in question are allocated the same single, common set of data (e.g. depth value, colour value, etc.) (rather than each having their own separate set of data as would be the case for supersampling).

Thus, in multisampling, plural samples are again taken for each pixel that will make up the final display, but rather than determining a separate colour value for each sample when rendering the “pixel” (as would be the case for a full supersampling system), a single colour value is determined and applied to all the samples for a display pixel that are found to belong to the same object in the final image. In other words multisampling calculates a single colour value for a given display pixel for a given object in the scene, which colour value is applied to (reused for) all samples (subpixels) of the display pixel that are covered by that object (in contrast to supersampling where a separate colour value is determined for each sample).

Because only a single colour value is used for multiple samples for a given display pixel, multisampling is less processing intensive than supersampling and therefore can allow faster processing and performance than supersampling. However, there is a reduction in the quality of the displayed image as compared to supersampling, since although objects' edges are still sampled at a higher resolution, colours are not.

Notwithstanding this, many graphics processing systems use a multisampling anti-aliasing technique, as multisampling can in general provide adequate (and improved as compared to when there is no multisampling or supersampling at all) anti-aliasing in a rendered image, but without the significant extra processing and computational burden that full supersampling entails.

It would also be possible in both supersampling and multisampling arrangements, to improve the anti-aliasing performance by taking more samples for each display pixel. For example, instead of taking 4 samples for each display pixel (4× anti-aliasing), 16 samples could be taken instead (16× anti-aliasing). However, this would have the effect of dramatically increasing the processing requirements (by a factor of four if going from 4× to 16×) as more fragments will need to be processed to process the increased number of samples and so may not necessarily be desirable or possible.

The Applicants believe therefore that there remains for improvements to anti-aliasing techniques but which that do not have too high performance penalties.

According to a first aspect of the present invention, there is provided a method of processing graphics for display, the method comprising:

generating and rendering graphics fragments to generate rendered graphics data for sampling points of an image to be displayed; wherein:

each graphics fragment that is rendered has associated with it a set of sampling points of the image to be displayed and is to be used to generate rendered graphics data for one or more of the sampling points of the set of sampling points associated with the fragment; and

the graphics fragments that are rendered can be associated with sets of sampling points containing different numbers of sampling points.

According to a second aspect of the present invention, there is provided a graphics processing system comprising:

means for generating and rendering graphic fragments to generate rendered graphics data for sampling points of an image to be displayed; wherein:

each graphics fragment that is rendered has associated with it a set of sampling points of the image to be displayed and is to be used to generate rendered graphics data for one or more of the sampling points of the set of sampling points associated with the fragment; and

the graphics fragments that are rendered can be associated with sets of sampling points containing different numbers of sampling points.

In the present invention, an image is processed for display by rendering fragments that each correspond to a set of sampling points of the image. However, in the present invention, the fragments that are rendered for the image can be associated with (correspond to and represent) sets of sampling points that contain different numbers of sampling points. For example (and as will be discussed further below) in one preferred embodiment, a given fragment that is rendered can be associated with a set of sampling points containing 4 sampling points of the image, or it can be associated with a set of sampling points containing 16 sampling points of the image.

The present invention accordingly provides an arrangement in which an individual fragment that is to be rendered can be used to represent different numbers of sampling points. This provides, inter alia, flexibility in terms of the number of fragments that need to be sent through the rendering process (pipeline) for rendering a given number of sampling points.

For example, in a system where each fragment always corresponds to four sampling points (a 4× sampling mask), then to achieve 16× sampling, one would have to render four times as many fragments (with the performance penalties that that then entails, as discussed above).

However, in the present invention, if, for example, as discussed above, a given fragment could be used to represent 4 or 16 sampling points, then if one wished to use 16× sampling, then where for example, it was found that the same primitive covered all 16 sampling points of a given 16× sampling mask, a single fragment having a 16 sampling point set associated with it could be used to render all 16 sampling points of the covered 16× mask, rather than having to use four fragments to do so. On the other hand, where a given primitive did not cover all 16 sampling points of a given 16× mask, that 16× mask could instead, for example, be rendered using fragments each corresponding to four sampling points to allow for the incomplete coverage of the 16 sampling points of the mask to be reflected in the rendering process.

Thus the present invention can, inter alia, effectively allow an increased sampling rate (anti-aliasing rate, etc.) to be used, but without the need to completely scale up the number of fragments that are rendered to fully match the increased sampling rate. This is because the present invention allows some fragments to be used to render greater numbers of sampling points, thereby avoiding the need to instead render a greater number of fragments to render those sampling points. In particular, while it is true that for an increased sampling rate the present invention may still require an increase in the number of fragments that are rendered, that will be a smaller increase in the number of fragments than if the present invention were not used and the number of fragments rendered was simply scaled up to achieve the increased sampling rate.

Moreover, the Applicants have recognised that the increase in the number of fragments to be rendered in the present invention for an increased sampling rate will in practice be relatively small, since in most cases the higher sampling rate masks used to sample the image will be fully covered by a given primitive and so can still be rendered using a single fragment (but representing more sampling points) and so not require the rendering of additional fragments to achieve the higher sampling rate.

The Applicants accordingly believe that the present invention can allow higher rates of anti-aliasing to be achieved, but without needing a significant increase in the size and power of the graphics processor and with only a relatively small, if any, performance drop.

It will be appreciated here that in the present invention, fragments can be dynamically associated with sets of sampling points containing different numbers of sampling points in use. Thus, for example, for any given image (frame) being rendered, fragments that are generated to render that image can (preferably) be associated with sets of sampling points having different numbers of sampling points. Most preferably, for any given primitive being rendered, fragments being used to render that primitive can be associated with sets of sampling points having different numbers of sampling points. Most preferably the fragments can be selectively associated with sets of sampling points having different numbers of sampling points, for example, and preferably, as will be discussed further below, on the basis of the coverage by a primitive of the sampling points in question.

The sets of sampling points that are associated with each fragment can be selected as desired. As is known in the art, each set of sampling points (and accordingly each sampling point) will represent a location (x, y position) in the image to be displayed.

The pattern and (relative) positions of the sample points in each set of sampling points (the sampling pattern) can be selected as desired. For example, any known suitable anti-aliasing sampling pattern can be used, such as ordered grid sampling. Most preferably a rotated grid sampling pattern is used, as that provides a better sampling effect, as is known in the art.

Where, as will typically be the case, the image is to be displayed on an output device having a display or output comprising a plurality of pixels, each set of sampling points that a fragment to be rendered may be associated with preferably corresponds to a set of sampling points for a given pixel (pixel location) of the output device (e.g., display), or to a set of sampling points for a part of a pixel (e.g. a sub-pixel) of the output device (e.g., display or printer). In the latter arrangement, a group of plural of the sets of sampling points preferably make up an overall set of sampling points for a pixel of the display. In these arrangements, each fragment will effectively render fragment data for a given pixel of the output device (e.g., display or printer).

The number of sampling points in the sets of sampling points that the graphics fragments to be rendered can correspond to (can represent) can be selected as desired. There may, for example, be multiple levels of sets of sampling points, each containing different numbers of sampling points, such as a set containing 1 sampling point, a set containing 4 sampling points, a set containing 16 sampling points, a set containing 64 sampling points, and so on. In a particularly preferred embodiment, each set of sampling points that a graphics fragment can correspond to contains plural sampling points. Preferably graphics fragments can be associated with sets of 4 or of 16 sampling points.

In a particularly preferred embodiment, there are only two different sets of sampling point numbers (levels) that a fragment can be associated with. Most preferably these sets are a set of 4 sampling points and a set of 16 sampling points.

Preferably the number of sampling points in each different numbered set of sampling points is related to the number of sampling points in its immediately neighbouring set (or sets) of sampling points in the hierarchy by the same multiplying factor. Preferably each set has four times as many sampling points as its immediate lower numbered neighbour.

Similarly, each smaller set of sampling points that a fragment can correspond to preferably corresponds to or represents a particular portion or sub-region of a larger set of sampling points, such as a particular row or column of the larger set of sampling points. In a particularly preferred such arrangement, each smaller set of sampling points represents and corresponds to a quarter or a quadrant of its immediately larger neighbouring set of sampling points. Thus, for example, where a given fragment can be associated with a set of 16 sampling points or a set of 4 sampling points, each set of 4 sampling points can preferably be used to represent a quarter or a quadrant of the set of 16 sampling points.

In a particularly preferred embodiment, the sets of sampling points that fragments can be associated with each correspond to a sampling mask (an anti-aliasing mask) or to a part of such a mask, that can be and is intended to be applied to an image to be rendered in the graphics processing system in question. As known in the art, when an image is to be rendered for display, typically a predefined sampling mask representing a set of sampling points will be repeatedly applied to the image to sample the image. Typically, and preferably, each application of the sampling mask will correspond to a given output pixel of the intended output device (e.g., display or printer).

Thus, for example, preferably a set of 16 sampling points, which will correspond to a 16× sampling (e.g., and preferably, multisampling) mask and a set of 4 sampling points, which can correspond to a 4× sampling mask or to a quarter of a 16× sampling mask, can be associated with a fragment.

Thus in a particularly preferred embodiment a given graphics fragment can be associated with (and be used to render) all of the sampling points of a sampling mask (or anti-aliasing mask) that is to be applied to the image to be rendered, or can be associated with (and be used to render) a subset of the sampling points of the sampling mask that is to be applied to the image to be rendered. In other words, preferably a given application of a sampling mask to the image can be rendered using either a single fragment that represents the entire sampling mask or by using a fragment or fragments that represent subsets of the sampling mask or by a combination of such fragments.

Similarly, a given instance of the sampling mask can preferably be rendered using a fragment corresponding to the entire sampling mask and/or using fragments corresponding to particular sub-regions or parts of the sampling mask, such as corresponding to a row, a column, or, preferably, a quarter or a quadrant, of the sampling mask.

It will be appreciated that in these arrangements, the present invention will, in effect, allow a given sampling mask (e.g., multisampling mask), such as a 16× mask, to be represented by and processed as a single fragment, or to be processed as plural fragments (e.g. to be divided into one or more smaller fragments for rendering). In effect, the sampling mask can be represented at two (or more) different levels for the purpose of rendering, such that, for example, if the whole mask is covered it can be rendered as a single fragment (at one “level”), but if it is only partially covered, it can, e.g., be rendered as one or more larger and/or smaller “patches” (be divided into smaller patches for rendering), e.g. using fragments associated with smaller numbers of sampling points (at a lower level). This is advantageous, as discussed above. Thus according to a third aspect of the present invention, there is provided a method of processing graphics for display in a graphics processing system in which a sampling mask comprising a set of sampling points is to be applied to an image to be displayed for sampling the image to be displayed, and wherein:

the set of sampling points corresponding to a given application of the sampling mask to the image can be rendered to generate rendered graphics data for that set of sampling points either using a single fragment or using plural fragments.

According to a fourth aspect of the present invention, there is provided a graphics processing system in which a sampling mask comprising a set of sampling points is to be applied to an image to be displayed for sampling the image to be displayed and wherein:

the set of sampling points corresponding to a given application of the sampling mask to the image can be rendered to generate rendered graphics data for that set of sampling points either using a single fragment or using plural fragments.

Similarly, according to a fifth aspect of the present invention, there is provided a method of processing an image for display in a graphics processing system, the method comprising:

applying a sampling mask comprising a set of sampling points to an image to be displayed to sample the image to be displayed; and

generating and rendering graphic fragments in order to generate rendered fragment data for sampling points of the image for display; wherein:

each fragment that is rendered can have associated with it a set of sampling points corresponding to all of the sampling points of the sampling mask or a set of sampling points corresponding to a sub-set of the sampling points of the sampling mask.

According to a sixth aspect of the present invention, there is provided a graphics processing system, comprising:

means for applying a sampling mask comprising a set of sampling points to an image to be displayed for sampling the image to be displayed;

means for generating and rendering graphics fragments to generate rendered fragment data for sampling points of the image for display; and

means for associating with each fragment that is rendered a set of sampling points corresponding to all the sampling points of the sampling mask or a set of sampling points corresponding to a sub-set of the sampling points of the sampling mask.

As will be appreciated by those skilled in the art, these aspects and embodiments of the invention can and preferably do include any one or more or all of the preferred and optional features of the invention described herein, as appropriate. Thus, for example, the anti-aliasing mask preferably contains 16 sampling points, and preferably can be rendered using fragments corresponding to 16 or to 4 sampling points.

Preferably, the anti-aliasing masks can be rendered using a fragment representing the entire mask or using a fragment representing a particular sub-region or portion of the sampling mask.

Most preferably, a given instance of an applied sampling mask can be rendered using a single fragment representing all of the sampling points of the mask, or can be rendered using one or more fragments corresponding to smaller portions or sub-regions (e.g. quarters or quadrants) of the mask, or can be rendered using both a fragment representing all of the sampling points of the mask, and as one or more fragments corresponding to smaller portions or sub-regions of the sampling mask.

Although in the present invention fragments may be associated with sets of sampling points containing different numbers of sampling points, typically, and preferably, the individual sampling points in the different numbered sets of sampling points that a fragment can be associated with when the present invention is used will always be at the same sampling resolution for all the different numbered sets of sampling points, irrespective of how many sampling points are in each set.

Thus, for example, if a 16× sampling mask is applied to an image, the present invention would, e.g., use one fragment corresponding to 16 sampling points to render all 16 points of the mask, or, e.g., use one or more fragments, each corresponding to, say, four sampling points of the mask, to render sampling points of the mask. However, the individual sampling points of each set would themselves always each represent the same sampling resolution; it is just that a given fragment can be used to render more or less of those sampling points.

Thus, in a particularly preferred embodiment, the sampling points in the sets of sampling points that can be associated with fragments in the present invention each represent the same sampling resolution in the image being sampled.

In the present invention, a given graphics fragment can be associated with sets of sampling points containing different numbers of sampling points. Equally, a given sampling mask, for example, can be processed using a single fragment, or using plural fragments, and/or using fragments representing different sub-portions of the sampling mask. Thus, the number of sampling points to be associated with a fragment(s) can be varied dynamically, in use. This can preferably be done selectively, as a given image is processed for display.

Thus, the present invention preferably comprises steps of or means for selecting the set of sampling points to be associated with a fragment to be rendered.

Similarly, the present invention preferably comprises steps of or means for selectively processing the set of sampling points of a sampling mask applied to an image to be displayed as a single fragment representing all the sampling points of the sampling mask, or as one or more fragments each representing a sub-set of the sampling points of the sample mask, or as a combination of a fragment representing all the sampling points of the sampling mask, and of one or more fragments each representing a sub-set of the sampling points of the sampling mask.

Thus, in a particularly preferred embodiment, the present invention comprises steps of or means for selectively associating with each fragment that is rendered a set of sampling points corresponding to all the sampling points of the sampling mask or a set of sampling points corresponding to a sub-set of the sampling points of the sampling mask.

The selection of what set of sampling points to associate with a given fragment and the selection of how to process a given instance of a sampling mask is preferably based on the coverage of the sets of sampling points, and/or of the sampling mask, by the primitive being processed (sampled).

Thus, for example, and preferably, if a given sampling mask (set of sampling points) is completely covered by a primitive, then it is preferably rendered using a single fragment corresponding to all the sampling points of the sampling mask. However, if the sampling mask is not completely covered by the primitive being sampled, the sample mask may instead, e.g., be processed as one or more fragments each corresponding to sub-patches of the sampling mask.

Thus, in a particularly preferred embodiment, the present invention includes steps of or means for determining the coverage of a set of sampling points by a primitive to be rendered, and selecting the number of sampling points to be associated with a fragment to be rendered based on the determined coverage of the sampling points by the primitive being sampled.

Similarly, the present invention preferably comprises steps of or means for determining the coverage of a sampling mask comprising a set of sampling points by a primitive to be rendered and selectively rendering the set of sampling points corresponding to the sampling mask either as a single fragment corresponding to all the sampling points of the sampling mask, or as one or more fragments corresponding to subsets of the sampling points of the sampling mask, or as a combination thereof, based on the coverage of the sampling mask by the primitive to be rendered.

Thus, in a particularly preferred embodiment, the present invention comprises steps of or means for processing a graphics primitive of an image to be displayed, by:

determining for each sampling point of a set of plural sampling points whether the graphics primitive covers the sampling point; and,

if the primitive covers all the sampling points of the set of sampling points, generating a single graphics fragment corresponding to the set of plural sampling points to be rendered to generate rendered fragment data for the sampling points; or,

if the primitive does not cover all the sampling points of the set of sampling points, selectively generating one or more fragments associated with all or a subset of the sampling points of the set of sampling points for rendering to generate rendered fragment data for the sampling points.

It will be appreciated that although in many cases in operation of the present invention, the set of sampling points that a fragment corresponds to will be completely covered by the object (e.g., primitive) being sampled, this will not always be the case and in that case only some but not all of the sampling points associated with the fragment will be covered by the, e.g., primitive, in question. In the latter case, the rendered fragment data for the fragment should be used for those sampling points that are covered (by the primitive), but not used for those sampling points that are not covered (by the primitive) (since those sampling points will in practice be covered by another, e.g., primitive, of the image), as is known in the art. There would, e.g., be no need to store the rendered fragment data in a rendered fragment data array for those sample positions that are not covered.

Thus, in a particularly preferred embodiment, each graphics fragment has associated with it data indicating which of the sampling points in the set of sampling points that the fragment corresponds to are covered (e.g., and preferably, by the primitive being sampled), i.e. in effect, which of the sampling points in the set of sampling points that the fragment corresponds to, the fragment is being used to render. The system preferably then operates to store the rendered fragment data in a fragment data array for the indicated covered sample positions, but not for the remaining sample positions associated with the fragment.

The information indicating which covered sample points the fragment is being used to render is preferably associated with or part of the fragment data for the fragment that passes through the renderer (such as the RGB and alpha values for the fragment). It is preferably in the form of a coverage mask that indicates, for each sample position of the set of sample positions that is associated with the fragment, whether that sample position is covered, i.e., in effect, whether the fragment is being used to render that sample point (i.e. whether its data should be stored for that sample point). Preferably this coverage mask is in the form of a bitmap that represents the sampling positions. This arrangement has been found to be a particularly convenient way of associating a given fragment with the appropriate sample points.

In these arrangements, while it would be possible to specify the coverage of each sample position individually in the coverage information associated with a fragment (e.g., to use a 16-position coverage mask for a fragment corresponding to a set of 16 sampling points and to use a 4-position coverage mask for a fragment corresponding to a set of 4 sampling points), in a preferred embodiment the coverage information (mask) can (selectively) indicate the coverage of plural sample positions collectively (preferably with a single bit). This allows a smaller coverage mask, etc., to be used, even if the fragment corresponds to more sampling positions.

Most preferably each fragment is associated with the same sized coverage mask (in terms of the number of sampling positions the coverage mask can indicate as being covered or not), irrespective of how many actual sampling positions the fragment may represent. In other words, the coverage information (mask) used with the fragments preferably has a fixed number of positions (e.g., and preferably, 4) that it can indicate as being covered or not, and each such position represents either one or a plurality of sampling points, depending on how many sampling points there are in the set of sampling points associated with the fragment in question.

In a particularly preferred such embodiment, each fragment has associated with it coverage information (a coverage mask) representing four possible sampling positions, and each such position of the coverage mask can either represent a single sampling point (if the fragment is associated with a set of 4 sampling points), or 4 sampling points (if the fragment is associated with a set of 16 sampling points).

It is believed that such arrangements may be new and advantageous in their own right.

Thus, according to a seventh aspect of the present invention, there is provided a method of processing graphics for display, comprising:

associating with graphics fragments to be rendered a coverage mask for indicating the covered sampling positions each fragment is being used to render; wherein:

each coverage mask has a number of positions that can each be used to indicate whether a sampling point is covered or not; and

a fragment can be selectively associated with a coverage mask in which each such position in the coverage mask represents a first number of sampling points of the image or with a coverage mask in which each such position in the coverage mask represents a second, different number of sampling points of the image.

According to an eighth aspect of the present invention, there is provided a graphics processing system comprising:

means for associating with graphics fragments to be rendered a coverage mask for indicating the covered sampling positions each fragment is being used to render; wherein:

each coverage mask has a number of positions that can each be used to indicate whether a sampling point is covered or not; and

a fragment can be selectively associated with a coverage mask in which each such position in the coverage mask represents a first number of sampling points of the image or with a coverage mask in which each such position in the coverage mask represents a second, different number of sampling points of the image.

As will be appreciated by those skilled in the art, these aspects and embodiments of the invention can and preferably do include any one or more or all of the preferred and optional features of the invention described herein, as appropriate. Thus, for example, each coverage mask position can preferably represent either one or four sampling points. Similarly, the coverage mask is preferably in the form of a four position bit-map.

Where the same coverage mask structure is used for all fragments, irrespective of how many sampling positions the fragment represents, then preferably each position in the coverage mask (information) represents a corresponding position or set of positions in the sets of sampling points. Thus, for example, where a four-position coverage mask is used, and fragments can be associated with 4 or 16 sampling points, each position in the coverage mask when used for a 16-sampling point fragment preferably represents the quarter or quadrant of four sampling points of the 16-sampling point set corresponding to that position.

As well as information relating to the coverage of the sampling points that a given fragment corresponds to, it may also be necessary in the present invention to provide information indicating, e.g., the size of the set of sampling points that a fragment corresponds to, and/or the sub-set (sub-position) within, e.g., a given sampling mask, that a fragment corresponds to. This information may be provided as desired, for example, by again associating it with the fragment in question, e.g., using spare capacity that may be available in existing fragment data fields.

Although the above arrangements have been described with particular reference to the use of fragments representing a 16× sampling mask and a quarter of such a mask, other arrangements would, of course, be possible, and, in one preferred embodiment, are used.

It would, for example, be possible to represent the 16× sampling mask in a different way using the 4-bit position coverage mask for a fragment, if desired. For example, each bit position in the coverage mask need not represent a quadrant of the 16× mask, but could, e.g., represent a row or column, or some other portion, of the 16× mask.

It would also be possible (and in one preferred embodiment, this is done) to have more than one level of sub-division of the sampling mask, so that, for example, the system could use a 64× sampling mask, that could then be represented as a 64× “patch”, as one or more 16× “sub-patches” and/or as one or more 4× “sub-patches”, and so on. It would similarly also be possible (and in one preferred embodiment, this is done) to do any sampling mask sub-division in one direction only, so as to have, e.g., 32× and/or 8× “sub-patches” if desired.

Also, for example, a coverage mask denoting no (“zero”) coverage could be defined as representing instead another coverage pattern (instead of zero coverage), such as corresponding to a different form of coverage mask, where, as may be the case, in practice there would never be any desire to send a fragment having a coverage of zero through the rendering process (such that a coverage “zero” mask is effectively a “spare” coverage mask value).

It will be appreciated that in the present invention a given instance of an applied sampling mask, for example, may, e.g., be rendered as a single fragment representing all of the sampling points of the mask, or may, e.g., be rendered as one or more fragments corresponding to smaller portions of the mask, or a combination of two. It may accordingly be desirable to ensure that the same rendered data values (e.g., resultant colour values) are generated for the relevant sampling points irrespective of whether the “mask” is rendered using a single fragment corresponding to the entire mask or not.

Thus, in a preferred embodiment, the processing of the fragments is configured such that the same rendered fragment data values can be (and will be) generated for each respective sampling point, irrespective of the number of sampling points in the set of sampling points associated with the fragment being used to render the sampling point (e.g., and preferably, irrespective of whether a given instance of the sampling mask is being rendered using a single fragment or as one or more sub-patches).

Thus, in a preferred embodiment, if centroid mapping is disabled, the same barycentric co-ordinates are used for each fragment, regardless of how many sampling points there are in the set of sampling points associated with the fragment (i.e. such that, inter alia, a fragment that is associated with a set of sampling points that contains less sampling points than the full sampling mask (i.e., where the sampling mask is being processed using smaller “patches”) uses the same barycentric coordinates as a fragment that represents the full sampling mask). This should have the effect that the texture co-ordinates for each smaller “patch” fragment will be the same as when a single fragment is used for all sampling points of the sampling mask. This should also, in fact, have the effect of speeding up the processing, as the texture-cache should experience more hits.

On the other hand, if centroid mapping is enabled, then preferably centroid mapping is applied individually to each fragment that corresponds to a sub-set (a sub-patch) of the sampling mask.

It is also the case that some graphics processors render fragments in particular groupings, such as in 2×2 groups, and require particular group arrangements, or orders, for the purpose of, e.g., generating data, such as for deriving derivatives, to be used for the rendering process. In this case where fragments each corresponding to a sub-set of the sampling mask are being rendered, then the fragments are, where necessary, preferably processed through the rendering process in appropriate groupings (e.g., as 2×2 groups), with each grouping, e.g., including, e.g., in the appropriate position in the group, a fragment representing sampling points from each respective original sampling mask, so as to preserve the correct data e.g., derivative generation result.

Alternatively or additionally, additional information (data) could be included with a fragment or fragments to be rendered (e.g., by placing such data in redundant sampling point positions of fragments to be rendered) to allow data needed for the fragment that is being rendered, such as derivatives, that may depend on other fragments, or sampling mask applications, etc., still to be derived when the fragments are rendered.

The generation and rendering of the fragments in the present invention can be carried out in any suitable and desired manner, and may involve, for example, any suitable and desired rasterising and then rendering processes. The rendering processes may include, for example, fragment shading, blending, texture-mapping, etc.

The “allocation” of the sampling mask to single or plural fragments, etc., can similarly be done in any suitable and desired manner. It is preferably done as part of the rasterisation process, or after rasterisation but before the fragments enter the “shading” (rendering) pipeline, as this will be more convenient.

The rendered fragment data that is determined and stored for each fragment and sampling point should be stored in an appropriate sample data array, as is known in the art. This array should, as is known in the art, represent a two-dimensional array of, e.g., sampling positions, that can then be processed appropriately to, e.g., display a 2D array of pixels.

As will be appreciated by those skilled in the art, where the present invention is used to process an image at, say 16× sampling, as against 4× sampling, that will result in rendered fragment data for four times as many sampling positions.

It would be possible simply to increase the size of the rendered fragment data array to allow for this. However, in one preferred embodiment, where a higher sampling rate is used, the rendered fragment data is stored in a compressed form. This can avoid the need to increase the size of the rendered fragment data array, but still should not be too detrimental to the output image quality, as the compression will be at sub-display pixel level and so any compression artefacts will only very rarely be inherited to the display pixel level.

It should be noted here that, as will be appreciated from the above, the present invention relates to the generation and rendering of fragments so as to generate rendered graphics data for the respective sampling points (and not, e.g., to the process of reading already generated sample data in order to display that data). The so-generated rendered data will then, as discussed above, be stored in a suitable sample data array or buffer, such as a tile and/or frame buffer, for subsequent provision to a display device, as is known in the art. There may be, as is known in the art, downsampling, either in a fixed or in a variable fashion, from the sample buffer to the frame buffer and/or output display, if desired.

It will be appreciated that as an image to be displayed will typically be made up of plural primitives, in practice the method of the present invention will be repeated for each primitive making up the image, so that eventually an appropriate set of rendered fragment data has been generated for each sampling point of the image that is needed to display the entire image (or relevant part of the image, e.g., in a tile-based rendering system), which data can then be, e.g., downsampled for display. Preferably the same sized sample mask is applied across the entire image being sampled.

A given graphics processor could be configured to always operate in the manner of the present invention. However, in a preferred embodiment the arrangement is such that a graphics processor can selectively be set to operate in the manner of the present invention.

Most preferably, the graphics processor can either operate in the manner of the present invention, or can render images using a fixed set of sampling points for each fragment. For example, in a particularly preferred embodiment, a graphics processor that can operate in the manner of the present invention can be selectively configured either to process images for display using a 4× sampling mask (in which case the present invention will not be used), or using a 16× sampling mask, in which case the present invention is used.

Most preferably these different modes of operation can be set by the application that is calling for the graphics processing. This would then allow, e.g., an application developer to choose between, say “normal” 4× multisampling, or 16× multisampling using the present invention. Indeed, it is an advantage of the present invention that it facilitates using different multisampling, etc., rates, without the need for significant changes to the processor hardware.

In a particularly preferred embodiment, the various functions of the present invention are carried out on a single graphics processing platform that generates and outputs the data that is written to the frame buffer for the display device.

The present invention is applicable to any form or configuration of renderer, such as renderers having a “pipelined” arrangement (in which case the renderer will be in the form of a rendering pipeline). In a preferred embodiment it is applied to a hardware graphics rendering pipeline. The various functions and elements, etc., of the present invention can be implemented as desired, for example, and preferably, by appropriate functional units, processing logic, processors, circuitry, processing circuitry, microprocessor arrangements, etc.

The present invention is applicable to all forms of rendering, such as immediate mode rendering, deferred mode rendering, tile-based rendering, etc., although it is particularly applicable to graphics renderers that use deferred mode rendering and in particular to tile-based renderers.

As will be appreciated from the above, the present invention is particularly, although not exclusively, applicable to 3D graphics processors and processing devices, and accordingly extends to a 3D graphics processor and a 3D graphics processing platform including the apparatus of or operated in accordance with any one or more of the aspects of the invention described herein. Subject to any hardware necessary to carry out the specific functions discussed above, such a 3D graphics processor can otherwise include any one or more or all of the usual functional units, etc., that 3D graphics processors include.

The invention similarly extends to a 2D graphics processor and to 2D graphics processing.

It will also be appreciated by those skilled in the art that all of the described aspects and embodiments of the present invention can, and preferably do, include, as appropriate, any one or more or all of the preferred and optional features described herein.

The methods in accordance with the present invention may be implemented at least partially using software e.g. computer programs. It will thus be seen that when viewed from further aspects the present invention provides computer software specifically adapted to carry out the methods herein described when installed on data processing means, a computer program element comprising computer software code portions for performing the methods herein described when the program element is run on data processing means, and a computer program comprising code means adapted to perform all the steps of a method or of the methods herein described when the program is run on a data processing system. The data processor may be a microprocessor system, a programmable FPGA (field programmable gate array), etc.

The invention also extends to a computer software carrier comprising such software which when used to operate a graphics processor, renderer or microprocessor system comprising data processing means causes in conjunction with said data processing means said processor, renderer or system to carry out the steps of the methods of the present invention. Such a computer software carrier could be a physical storage medium such as a ROM chip, CD ROM or disk, or could be a signal such as an electronic signal over wires, an optical signal or a radio signal such as to a satellite or the like.

It will further be appreciated that not all steps of the methods of the invention need be carried out by computer software and thus from a further broad aspect the present invention provides computer software and such software installed on a computer software carrier for carrying out at least one of the steps of the methods set out herein.

The present invention may accordingly suitably be embodied as a computer program product for use with a computer system. Such an implementation may comprise a series of computer readable instructions either fixed on a tangible medium, such as a computer readable medium, for example, diskette, CD-ROM, ROM, or hard disk, or transmittable to a computer system, via a modem or other interface device, over either a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrink-wrapped software, pre-loaded with a computer system, for example, on a system ROM or fixed disk, or distributed from a server or electronic bulletin board over a network, for example, the Internet or World Wide Web.

A number of preferred embodiments of the present invention will be described by way of example only and with reference to the accompanying drawings, in which:

FIG. 1 shows schematically the effect of aliasing;

FIG. 2 shows schematically the supersampling anti-aliasing technique;

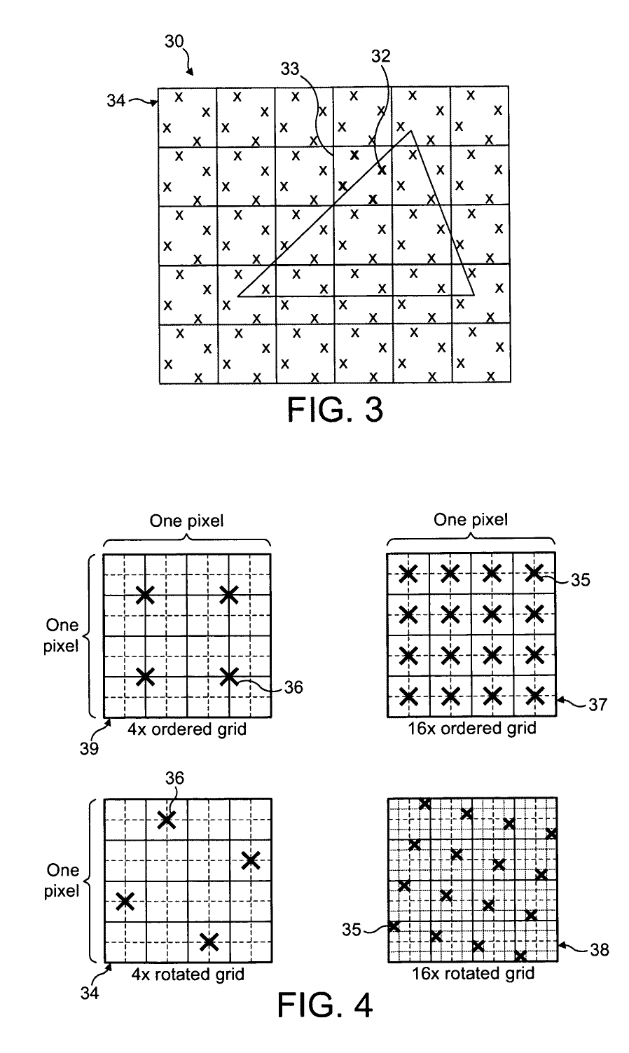

FIG. 3 shows schematically an image to be displayed;

FIG. 4 shows an exemplary sampling pattern for use in an embodiment of the present invention;

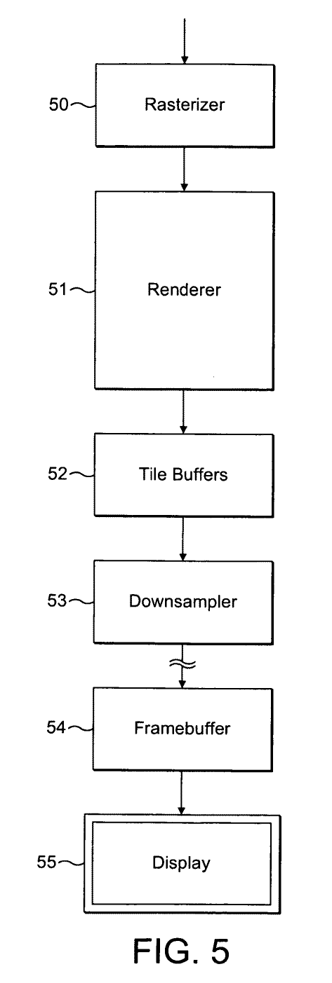

FIG. 5 shows an embodiment of a graphics processing platform that can be operated in accordance with the present invention;

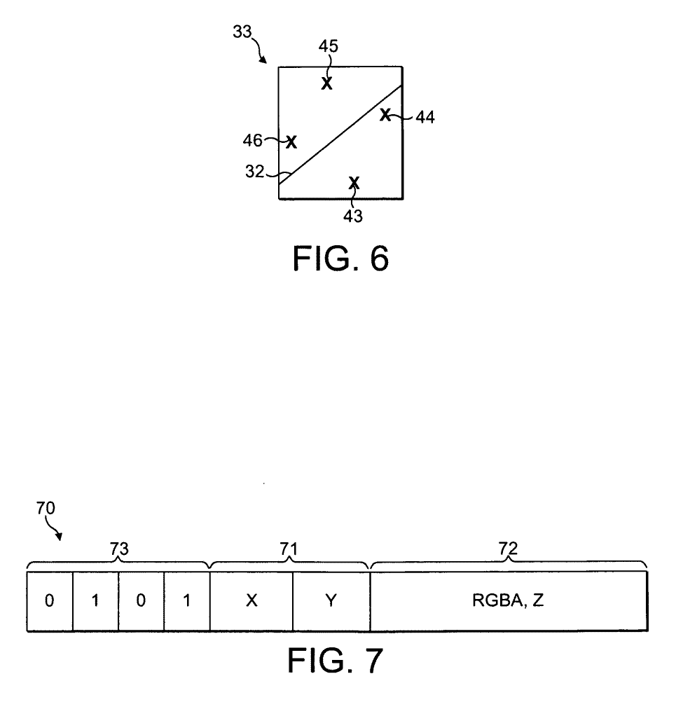

FIG. 6 shows an enlarged view of a pixel of FIG. 3;

FIG. 7 illustrates the data that is associated with a fragment to be rendered in an embodiment of the present invention;

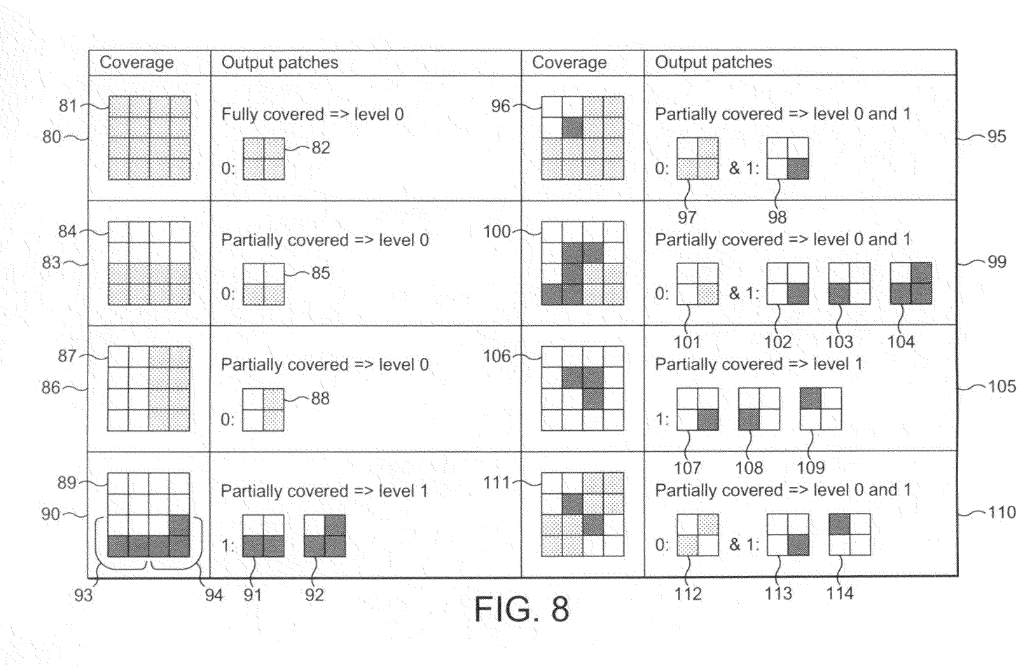

FIG. 8 shows schematically the association of fragments with sets of different numbers of sampling points in an embodiment of the present invention;

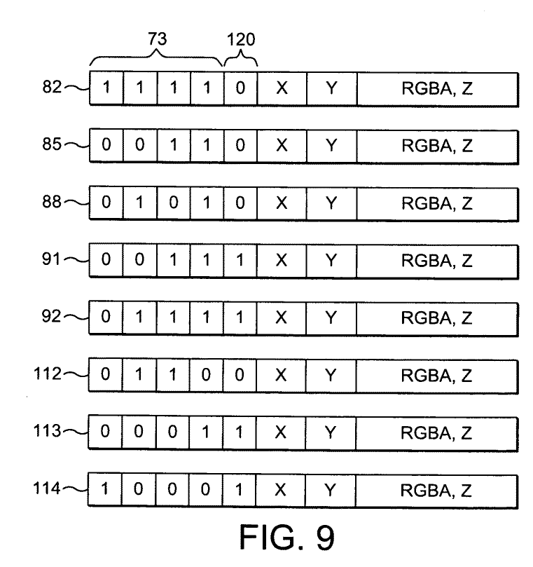

FIG. 9 illustrates the data that is associated with fragments to be rendered in an embodiment of the present invention; and

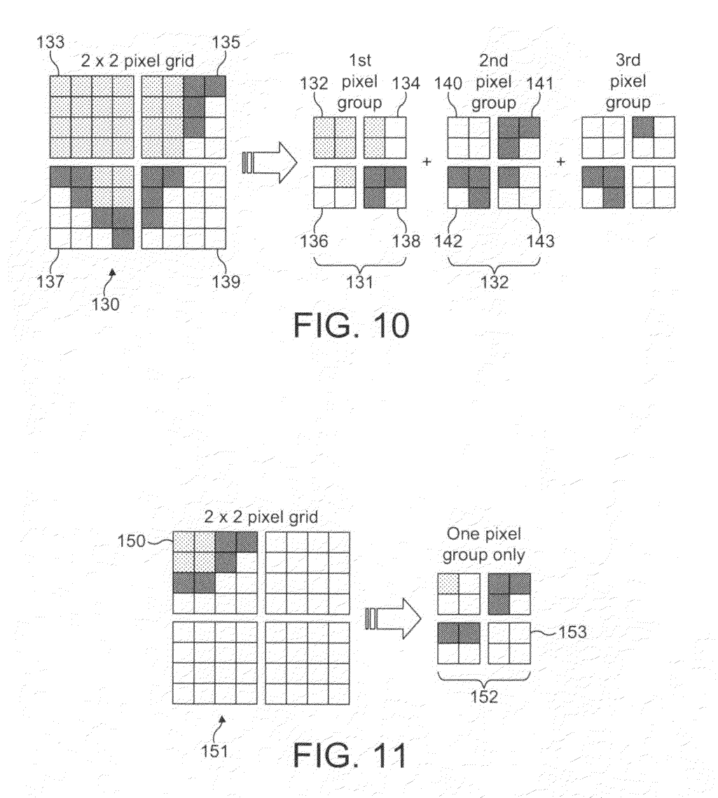

FIGS. 10 and 11 show schematically further preferred arrangements of the present invention.

A preferred embodiment of the present invention will now be described in the context of processing of 3D graphics for display. However, as will be appreciated by those skilled in the art, the present invention is not limited to the processing of 3D graphics and has other application as well.

As is known in the art, and as discussed above, when a 3D graphics image is to be displayed, it is usually first defined as a series of primitives (polygons), which primitives are then divided (rasterised) into graphics fragments for graphics rendering in turn. During a normal 3D graphics rendering operation, the renderer will modify the (e.g.) colour (red, green and blue, RGB) and transparency (alpha, a) data associated with each fragment so that the fragments can be displayed correctly. Once the fragments have fully traversed the renderer, then their associated data values are stored in memory, ready for output for display.

The present invention is particularly concerned with facilitating anti-aliasing operations when displaying graphics images. As is known in the art, anti-aliasing is carried out by taking plural samples of an image to be displayed and then downsampling those samples to the output resolution of the display.

FIG. 3, which shows schematically the basic anti-aliasing arrangement that is used in the present embodiment, shows the repeated application of a sampling mask 34 to an image to be displayed. Each application of the sampling mask 34 corresponds to a pixel of the image as it will be displayed.

Each sampling mask includes, as is known in the art, a set of sampling points that will be used to sample the image for the output pixel in question and accordingly determine how the pixel is to be displayed on the final display.

In the present embodiment, each instance of the sampling mask 34 can either take 16 sampling points or can take 4 sampling points of the image. FIG. 4, which shows an expanded view of these sampling masks, illustrates this.

FIG. 4 shows two 16× sampling masks 37, 38 which each represent an array of 16 sampling positions 35. The first mask 37 has an ordered grid of sampling positions 35, whereas the second mask 38 has a rotated grid of sampling positions. FIG. 4 also shows two corresponding 4× sampling masks 39 (having an ordered grid), 34 (having a rotated grid), which each represent a set of 4 sampling positions 36.

As will be discussed further below, in the present embodiment an image can be processed using either of the 4× or either of the 16× sampling masks shown in FIG. 4.

FIG. 3 also shows an image overlaid on the sampling mask array 30 in the form of a single primitive 32. (It will be appreciated here that the image has been shown in FIG. 3 as comprising a single primitive for simplicity, and in practice the image may and typically will comprise many, overlapping, primitives, as is known in the art.) As can be seen from FIG. 3, the primitive 32 overlies some of the sampling masks in the sampling mask array 30 completely, but only passes through part of some of the other sampling masks.

To process the primitive 32 of the image, the rendering system will, in essence, determine at the rasterisation stage which of the sample points in each set of sample points of each sampling mask application are covered by the primitive 32, and then render and store data for those covered sample points so that the image of the primitive 32 can be properly displayed on the display device.

The processing of the image of the primitive 32 for display in this manner in the present embodiment will now be described with reference to FIG. 5 which shows schematically an embodiment of a 3D graphics processing platform that can be operated in accordance with the present invention. The 3D graphics processing platform shown in FIG. 5 is a tile-based renderer, although as will be appreciated by those skilled in the art, other rendering arrangements can be used (and indeed, the present invention is equally applicable to two dimensional graphics processing as well).

The graphics processing platform shown in FIG. 5 includes a rasteriser 50 that receives graphics primitives for rendering and converts the primitive data to graphics fragments having appropriate positions for rendering the primitives.

There is then a renderer 51 in the form of a rendering pipeline that receives graphics fragments for rendering from the rasteriser 50 and applies a number of rendering operations, such as texture mapping, fogging, blending, etc., to those graphics fragments to generate the appropriate fragment data for display of the fragments. The rendered fragment data from the renderer 51 is stored in tile buffers 52 of the rendering pipeline for subsequent processing.

The tile buffers 52 store, as is known in the art, an array of fragment data that represents part of the image to be displayed. Once each tile has been processed, its data is exported to an appropriate storage, and the next tile is then processed, and so on, until sufficient tiles have been processed to display the entire image.

In the present embodiment, three tile buffers 52 are provided. Each tile buffer stores its fragment data in a 32×32 array (i.e. corresponding to a 32×32 array of sample positions in the image to be displayed). These tile buffers may be provided as separate buffers, or may in fact all be part of the same, larger buffer. They are located on (local to) the graphics processing platform (chip).

The data from the tile buffers 52 is input to a downsampling unit 53, and thence output to a frame buffer 54 (that may not be on the graphics processing platform itself) of a display device 55 for display on the display device 55, as is known in the art. The display device 55 could comprise, e.g., a display comprising an array of pixels, such as a computer monitor or a printer.

The downsampling unit 53 downsamples the fragment data stored in the tile buffers to the appropriate resolution for the display device 55 (i.e. such that an array of pixel data corresponding to the pixels of the display device is generated).

Thus, each 32×32 data position tile buffer will, for example, correspond to a 16×16 pixel array in the image to be displayed where 4× downsampling is used between the tile buffers and the display frame buffer (because in that case each pixel will effectively have four sampling points associated with it).

In this embodiment, two of the three tile buffers are used to store colour (red, green, blue) values for each sampling point (it would be possible to use one tile buffer for this purpose, but two is preferred), and one tile buffer is used to store Z (depth) values and stencil values for each sampling point. Other arrangements would, of course, be possible.

In the present embodiment, rather than rendering a separate fragment for each individual sample (data) position in the tile buffers 52 (i.e. for each individual sample point), one fragment is rendered for a set of plural sampling points.

This process will first be described where sampling masks having four sample positions (i.e. a 4× sampling mask) are to be applied to the image to be displayed.

In this case, one fragment is rendered for each set of four sample points corresponding to a given application of the sampling mask. In other words, a single fragment is used to render all four sample points of a set of sample points of a given application of the sampling mask (and accordingly of a pixel in the image) together in one go.

Then, once the fragment has been rendered, the rendered fragment data is stored in multiple copies in the appropriate sample positions in the tile buffers 52, so as to provide a separate set of fragment data for each individual sample position of the sampling mask.

Thus, in the present example, considering the image comprising the primitive 32 shown in FIG. 3, the rasteriser 50 will receive that primitive from the graphics processing system, and then determine which sets of sampling points of the image (i.e. in effect which applications of the sampling mask 34 in the array 30) include sampling points that are covered by the primitive 32. (This may be carried out in any appropriate manner known in the art.) The rasteriser 50 will then generate a fragment for each application of the sampling mask found to include a sampling point that is covered by the primitive 32. It will then pass those fragments to the renderer 51 for rendering.

FIG. 7 shows schematically the data 70 that is generated for each fragment before it is rendered and that passes through the renderer 51. As shown in FIG. 7, the data that is associated with each fragment includes, inter alia, the x,y position 71 of the fragment (which represents the x,y position in the image of the set of sampling points (the application of the sampling mask) that the fragment corresponds to (in practice in the present embodiment of the relevant pixel in the image)), together with the necessary per fragment data 72, such as the colour (RGB), transparency (alpha), depth (z) and stencil values for the fragment. This per fragment data 72 is, as is known in the art, used by and appropriately modified by rendering units of the renderer 51 to provide the output set of fragment data for the fragment that is then stored in the tile buffers 52.

The data 70 that is associated with the fragment also includes a coverage mask 73 that is in the form of a bit array representing each of the sample positions within the set of sample points (the sample mask) that the fragment corresponds to. Each position in the bit array coverage mask 73 is set to “1” if the corresponding sample position is found to be covered by the primitive in question at the rasterisation stage, and to “0” if the sample position is not covered by the primitive in question. This allows the rendering process to know which of the sample points associated with a given fragment are in fact covered by the primitive 32 in question, so that the rendering process can ensure that the rendered fragment data for a fragment is only used (and, e.g. stored) for the sample points that are covered by the primitive.

This is necessary, because, as can be seen from FIG. 3, not all the sampling points of a set of sampling points for an application of the sampling mask 34 will necessarily be covered by a primitive.

For example, as illustrated in FIG. 6, which shows an enlarged view of the set of sampling points for the sampling mask application (pixel) 33 in FIG. 3 in relation to the primitive 32 to be rendered, it can be seen that of the set of four sampling points for the sample mask 33, the sampling points 43 and 44 are covered by the primitive 32, but the sampling points 45 and 46 are not covered by that primitive.

The rasteriser 50 will therefore generate a fragment for rendering for the set of sample positions for sampling mask 33, since that set of sample positions includes two sample positions, 43, 44, that are covered by the primitive 32. However, because the primitive 32 only covers the sample positions 43, 44, the rendered fragment data should only be stored in the tile buffer 52 for those sample positions and not for the sample positions 45 and 46.

Therefore, for the set of sample positions for the sample mask (pixel) 33 shown in FIG. 6, the rasteriser will generate a coverage mask 73 of the form “0101” (as shown in FIG. 7), to indicate that the sample positions 43 and 44 are being rendered by the fragment 70, but that the sample positions 45 and 46 are not being rendered by the fragment (since they are not covered by the primitive 32).

Thus, when the rasteriser 50 receives the primitive 32 for rendering, it will firstly determine which sets of sampling points (sampling masks) of the array 30 include sampling points that are covered by the primitive 32, and for each of those sets of sampling points generate a fragment having associated with it data of the form shown in FIG. 7.

Each fragment will then be passed in turn to the renderer 51 for rendering. In the present embodiment, the fragments are sent to the renderer 51 for rendering in blocks of 2×2 fragments, i.e. such that the rendering engine effectively processes fragments in 4 fragment blocks, 2 fragments wide by 2 fragments tall. Other arrangements, such as processing fragments singly in the renderer, would, of course, be possible.

The renderer 51 will, as is known in the art, carry out rendering operations on the fragments that it receives. These rendering operations will, for example, include modifying the colour (RGB) and transparency (A) values of the fragments to provide final, rendered fragment data for each fragment. In the present embodiment, the renderer 51 includes a texture mapping stage that carries out a texture mapping process based on texture position data (s,t) that is associated with each fragment (this is not shown in FIG. 7).

In the present embodiment, the position within the image that the texture mapping process uses to determine the texture (colour) that will be applied to a fragment is selected in accordance with the locations (positions) in the image of the covered sampling points that the fragment is being used to render in common, i.e. a “weighted” texture sample position is used.

Other texture sample position arrangements would, of course, be possible. For example, all texture look-ups could simply be taken at the centre of the sampling pattern in question.

It will be appreciated here that because each fragment undergoes a single texture look-up, in the present embodiment the set of sampling points that each fragment corresponds to undergo a single texture look-up in common (i.e. the texturing operation is used for all the sample points of the set of sampling points associated with the fragment), i.e. the set of sampling points is effectively processed in a multisampled manner.

Once the fragments have been rendered, their data needs to be stored appropriately in the tile buffers 52. In accordance with the present embodiment, the data for each rendered fragment is stored in the appropriate sample position(s) in the tile buffer array as indicated by the coverage mask 73 associated with each fragment. Thus, in the case of the fragment 70 exemplified in FIG. 7, for example, the rendered data for that fragment will be stored in two of the sample positions in the tile buffers 52, but not in the other two sample positions, that are associated with the fragment 70.

The fragment data that is stored in the tile buffers 52 comprises the colour (RGB), transparency (A), depth (Z) and stencil values for each sample position, as discussed above. This data can be stored in any suitable form.

As will be appreciated by those skilled in the art, the newly rendered fragment data that is to be stored in the tile buffers may and typically will need to be blended with data that is already stored in the tile buffers, as is known in the art. Thus, where a given fragment is being used to render more than one sample position in common (i.e. such that data from the fragment will be stored in plural sample positions in the tile buffers), then this blending operation should be carried out in an appropriate manner to achieve this, i.e. to blend the newly rendered fragment data appropriately into each appropriate sample position in the tile buffers. Thus, for example, the blending operation could, for example, be carried out in an appropriately “parallel” fashion, to blend the rendered fragment data into the plural, parallel, tile buffers.

Once this process has been completed for all the fragments relating to the primitive 32, it can then be repeated for subsequent primitives of the image (since, as discussed above, the image will typically be made up of plural primitives, and not just a single primitive 32). The process is repeated for all the primitives of the image, until the tile buffers 52 have the appropriate data stored in each of their sample positions.

The data stored in the tile buffers can then be exported to the downsampling unit 53 for downsampling and subsequent exporting to the frame buffer 54 for display, as is known in the art. This downsampling can take place in any suitable manner. In the present embodiment linear blending of the data is used to downsample it. However, other arrangements would be possible, if desired.

In this arrangement, the downsampling unit 53 will provide 4× downsampling sampling operation, i.e. such that four data entries (i.e., 2×2 sample positions) stored in the tile buffers 52 will be downsampled to a single output data value (pixel) for the frame buffer 54. This is the normal mode of operation for the downsampling unit 53, since it will take four sample values, corresponding to the four samples that are taken for each pixel of the output image (as shown in FIG. 3) (since a 4× sampling mask is being used) and downsample them to a single value. In this arrangement, the 32×32 array tile buffers 52 will accordingly be downsampled to (and correspond to) a 16×16 pixel array in the frame buffer 54.

If needed, the downsampling unit 53 may also apply appropriate gamma correction to the data that it outputs to the frame buffer 54, or this may be done, e.g., as a fragment shading operation, or in any other suitable and desired manner.

Where the image to be displayed comprises plural, overlapping primitives, it will also, as is known in the art, be necessary for the rendering process to determine whether in fact any given primitive will actually be seen at a given sampling point. In the present embodiment this is carried out, as is known in the art, by comparing depth (z) values for fragments as they are rendered. In particular, when a new fragment is to be rendered, the depth (z) value associated with that fragment is compared with the depth values of fragment data already stored for the sample positions in the tile buffers 52 that the fragment corresponds to, and if that comparison indicates that the new fragment will not be seen, the new fragment is not processed any further. On the other hand, if the comparison of the depth values indicates that in fact the new fragment will be seen in place of the currently stored fragment in the tile buffers 52, then the new fragment is rendered and its rendered fragment data stored in place of the existing data for the appropriate sample positions in the tile buffers 52.

The above describes the operation of the present embodiment when a 4× sampling mask is applied to the image to be displayed. However, as discussed above, in the present embodiment it is also possible to use a 16× sampling mask when sampling the image to be displayed. The operation of the present embodiment when a 16× sampling mask is used will now be described.

When a 16× sampling mask is used for sampling the image in the present embodiment, the operation of the graphics processor is essentially the same as described above for the situation where a 4× sampling mask is being used. Thus, the sampling mask is applied to the image, samples are taken, fragments are generated and rendered to generate rendered fragment data for each covered sampling position, and the rendered samples are downsampled appropriately to provide output pixels for display.

Thus, unless otherwise indicated, the operation of the graphics processing system when a 16× sampling mask is being used is the same as the operation when a 4× sampling mask is being used. The following description will therefore focus on the differences between the two modes of operation.

The key difference in operation in the present embodiment when a 16× sampling mask is being used is that a given fragment when it is rendered can be associated either with all sixteen sampling positions of a given application of the 16× sampling mask, or it can be associated with only four sampling positions of the 16× sampling mask.

In particular, the 16× sampling mask can be divided into a two-level hierarchy for the purpose of associating its sampling points with fragments that are to be rendered, namely a first level in which a fragment is associated with all 16 sampling points of the 16× sampling mask, and a second level in which a fragment is only associated with four sampling points of the 16× sampling mask.

The effect of this then is that, as discussed above, for any given application of the sampling mask, if, for example, the sampling mask is completely covered by the primitive being sampled, a single fragment corresponding to all sixteen sampling points of the sampling mask can be used to render the sampling mask, whereas if the sampling mask is only partially covered by the primitive, it can, for example, be subdivided into smaller patches each corresponding to four sampling positions of the 16× sampling mask and rendered using a separate fragment. Thus, fully covered sampling masks will be rendered as a single fragment, while partially covered sampling masks might end up as 1 to 4 fragments.

The graphics processor determines at the rasterisation stage the coverage of each application of the sampling mask by the primitive (image) being sampled (rasterised), and then selectively processes and renders the sampling positions of each sampling mask application either as a single fragment corresponding to all 16 sampling positions of the sampling mask, or as one or more fragments corresponding to 4 sampling positions of the 16× sampling mask, or as a combination of a fragment corresponding to all 16 sampling positions and one or more fragments corresponding to 4 sampling positions, depending upon the coverage of the sampling positions of the 16× sampling mask by the primitive being sampled.

FIG. 8 illustrates this process, and shows examples of different coverages of a given application of the 16× sampling mask, and the corresponding sampling point “patches” that are associated with fragments to be rendered to render the sampling positions of the sampling mask.

In FIG. 8, a level “0” output patch represents a fragment that is associated with all 16 sampling positions of the 16× sampling mask. A level “1” output patch represents a fragment that is associated with 4 sampling positions of the 16× sampling mask. As shown in FIG. 8, in the present embodiment each level 1, four sampling position, fragment corresponds to a particular quadrant of the 16× sampling mask.

Thus, as shown in the first example 80 in FIG. 8, if the 16× sampling mask 81 is completely covered by the primitive being sampled, then the sampling mask is rendered as a single level 0 output patch, i.e., as a single fragment 82 corresponding to all 16 sampling points of the sampling mask 81. In this case, as shown in FIG. 8, as all the sampling positions are covered, the fragment 82 is denoted as having all its sampling positions covered.

In the second example 83 shown in FIG. 8, the lower half of the 16× sampling mask 84 is covered. In this case, the sampling mask 84 can again be rendered using a single level 0 fragment 85, corresponding to all 16 sampling points of the sampling mask 84, but in this case the coverage information associated with the fragment 85 indicates that only the lower half of the sampling mask is covered, as shown in FIG. 8.

Example 86 in FIG. 8 shows a similar situation, but in this case the right hand side of the 16× sampling mask 87 is covered. In this case, the sampling mask is again rendered as single fragment 88 corresponding to all 16 sampling points of the sampling mask 87, but the coverage information associated with the fragment 88 indicates that it is the right half of the sampling mask that is covered.

In the next example 90 shown in FIG. 8, the 16× sampling mask 89 is again partially covered, but in this case the coverage is such that no quarter (quadrant) of the sampling mask 89 is fully covered. In this case, the sampling mask 89 is accordingly rendered by generating two level 1 fragments 91, 92, each of which correspond to the 4 sampling points of the respective lower quarters of the sampling mask 89 where the covered sample positions lie. The fragment 91 corresponds to the quarter 93, and the fragment 92 corresponds to the quarter 94. There is no need to generate fragments for rendering the upper half of the sample mask 89, since that part of the sample mask is not covered.

Example 95 in FIG. 8 shows a further situation where the sample mask 96 is partially covered. In this case all except the upper left quarter of the sample mask 96 are fully covered, and so those sample positions can be rendered using an appropriate level 0 (i.e., 16 sampling point) fragment 97 as shown in FIG. 8.

The upper left quarter of the sampling mask 97 which is partially covered is then rendered using a single level 1, 4 sampling point, fragment 98. Again, it can be seen from FIG. 8 that the coverage information associated with the fragments 97, 98 indicates which sampling positions that the fragments correspond to are covered by the primitive.

(It should be noted here that the different shading of the covered sampling positions in FIG. 8 is used to illustrate the different fragment levels being used to render those sampling positions. It does not indicate that the sampling positions are covered by a different primitive).

Example 99 in FIG. 8 shows the situation where the lower right quarter of the 16× sampling mask 100 is fully covered, but the remaining quarters are only partially covered. In this case, the sampling mask 100 is rendered using a level 0, 16 sampling position fragment 101 to render the sampling positions of the lower right quarter of the sampling mask 100, and three level 1, 4 sampling point, fragments 102, 103 and 104, to render the remaining quarters of the sampling mask 100.

Example 105 in FIG. 8 again shows a different situation where the 16× sampling mask 106 is partially covered. In this case the lower left hand quarter of the sampling mask 106 is not covered, but the remaining quarters contain covered sampling points. This situation is rendered by generating three level 1, 4 sampling point, fragments 107, 108 and 109 corresponding to the respective quarters that contain covered sampling positions.

Finally, Example 110 in FIG. 8 shows a situation in which the upper right and lower left quarters of the 16× sampling mask 111 are completely covered, but the other quarters are only partially covered. In this case, the sampling mask 111 is rendered using a level 0, 16 sampling position, fragment 112 to render the sampling positions of the upper right and lower left quarters of the sampling mask 111, and two level 1, 4 sampling position fragments 113, 114 to render the covered sampling positions of the other quarters of the 16× sampling mask 111.

As shown in FIG. 8, it is necessary, as discussed above in relation to the use of 4× sampling masks, to indicate for each fragment which of the sample positions that the fragment corresponds to are covered. This is done using the coverage mask that is associated with each fragment, as discussed above and shown in FIG. 7.

FIG. 9 illustrates this.

Thus, for example, as shown in FIG. 9, for the fragment 82 that corresponds to the 16× sampling mask and is completely covered, that fragment when rendered has associated with it a coverage mask “1111”. Similarly, the partially covered fragment 85, which represents the full 16× sampling mask, has the coverage mask “0011” to indicate that it is the lower half of the sampling mask that is covered, and the fragment 88, which again represents the full 16× sampling mask, has as its coverage mask “0101” to indicate that the right half of the sampling mask is covered.

It should be noted that in each of these examples although the fragment represents and is being used to render all 16 sampling points of the 16× sampling mask, there are only four coverage positions represented by the coverage mask 73 associated with each fragment. Each respective coverage mask position accordingly actually indicates whether a quarter (quadrant), i.e., four sampling points, of the sampling mask is covered or not.

In order to allow for this possibility that a given position in the coverage mask 73 may in fact correspond to four sampling positions, each fragment has associated with it a level or hierarchy indicating field 120 which is set to “0” to indicate a level 0 fragment, i.e. a fragment representing all 16 sampling points of the coverage mask (and accordingly for which each coverage mask 73 position represents four sampling points of a quarter of the sampling mask), or set to “1” to indicate the fragment is a level 1 fragment corresponding to four sampling points only (and accordingly for which each position in the coverage mask 73 represents a single sampling point).

In the case of the fragments 82, 85 and 88, as shown in FIG. 9 this hierarchy field 120 is set to “0” to indicate that they are level 0 fragments corresponding to, and being used to render, all 16 sampling points of the sampling mask.

FIG. 9 also shows the fragment data for the fragments 91 and 92 of FIG. 8. In this case, the fragment 91 has the coverage mask “0011” since the lower half of that fragment is covered, and the fragment 92 has the coverage mask “0111”. Each of these fragments also has its hierarchy field 120 set to “1” to indicate that they are level 1 fragments, i.e., that the fragments correspond to four sampling positions only.

FIG. 9 finally also shows the fragments generated for rendering the sampling mask 111 shown in FIG. 8. In this case, as discussed above, there is a first, level 0, 16 sampling point fragment 112 that has the coverage mask “0110” and the level field “0”, and then two level 1 fragments (corresponding to four sampling points each), 113 and 114, having the sampling masks “0001” and “1000”, respectively, and their level fields 120 set to “1”.

It can be seen that the way the fragment data is configured in this embodiment allows the use of a 4-bit coverage mask even though fragments may correspond to 16 sampling positions. This avoids the need, for example, to have to use a 16-bit coverage mask for such fragments. An additional bit is used to indicate the “level” of the fragment (i.e., how many sampling points that the fragment corresponds to), but that still requires less additional data than if a 16-bit coverage mask was used.

It may also be necessary to indicate for each level 1 fragment which represents 4 sampling points only which quarter (quadrant) of the 16× sampling mask it corresponds to. This information may be provided, e.g., using two bits in a specific field of the fragment data added for this purpose, or in an existing field of the fragment data. However, even with these additional two bits for indicating the quarter that a fragment corresponds to, that still requires less data capacity than using a full 16 position coverage mask for each fragment.

It would, of course, be possible to represent the 16× sampling mask in a different way using the 4-bit position coverage mask for a fragment, if desired. For example, each bit position in the coverage mask need not represent a quadrant of the 16× mask, but could, e.g., represent a row or column, or some other portion, of the 16× mask.

It would also be possible to have more than one level of sub-division of the sampling mask, so that, for example, the system could use a 64× sampling mask, that could then be represented as a 64× “patch”, as one or more 16× “sub-patches” and/or as one or more 4× “sub-patches”, and so on. It would also be possible to do any sampling mask sub-division in one direction only, so as to have, e.g., 32× and/or 8× “sub-patches” if desired.

Also, for example, a coverage mask denoting no (“zero”) coverage could be defined as representing instead another coverage pattern (instead of zero coverage), such as corresponding to a different form of coverage mask, where, as may be the case, in practice there would never be any desire to send a fragment having a coverage of zero through the rendering process (such that a coverage “zero” mask is effectively a “spare” coverage mask value).

Once the fragments for rendering each application of the coverage mask have been generated and configured as discussed above in relation to FIGS. 8 and 9, they are sent to the rendering pipeline for rendering in the normal fashion. Once the fragments are rendered, their rendered fragment data is stored appropriately in the tile buffers 52 and finally downsampled for display, in the manner discussed above.

In this case, 16× downsampling will be applied, as there will be 16 sampling positions for each “output” pixel.

In order to facilitate this, in the present embodiment the downsampling unit 53 is arranged such that it can selectively apply two different levels of downsampling, namely 4× or 16× downsampling, to the data stored in the tile buffers 52. In this embodiment, the level of downsampling to be applied is set on a per frame basis, and is stored in an appropriate register that the rendering process can look up when it receives a frame for rendering.

In one preferred arrangement of the present embodiment, in order to allow the rendered fragment data to be stored at the same pixel resolution in the tile buffers when a 16× sampling mask is being used (i.e. such that each tile buffer still corresponds to a 16×16 array of output pixels, even though there are now 16 samples per output pixel, rather than four samples per output pixel (which will be the case when a 4× sampling mask is used)), the rendered fragment data for each sampling position when a 16× sampling mask is being used is compressed. Any suitable data compression technique can be used for this.

This compression does mean that there may be some lower quality, for example, colour-accuracy, when using a 16× sampling mask as compared to when using a 4× sampling mask, but any such loss of quality will be at the sub-output pixel level, and so any artefacts resulting from the compression should only be very rarely inherited to the output pixel-level, if at all. In the present embodiment, when a 16× sampling mask is being used, then for consistency with full 16× sampling mask processing (i.e., in which sampling points are not processed collectively as in the present embodiment), if centroid mapping is disabled, the barycentric coordinates for each of the fragments sent through the rendering process are set to be the same. This should ensure that each sub-sampling mask fragment has the same texture co-ordinate lookup as normal 16× sampling would have. (It should also result in a speed up in the processing as the texture-cache should experience more hits).

On the other hand, if centroid mapping is enabled, then centroid mapping is carried out for each fragment individually (each fragment gets its own texture coordinate).

Also, as discussed above, in the present embodiment, the rendering process renders fragments in 2×2 groups. Where centroid mapping is not enabled, it may not be necessary to send the same sub-mask fragment down the pipeline for each of the 2×2 fragments, as the barycentric coordinates will be fixed for all sub-mask fragments as described above. However, there may still need to be some ordering or configuration of the fragments being rendered in each 2×2 group, e.g., for the purpose of deriving derivatives.

In this case, preferably each 2×2 fragment group that is processed includes in the appropriate position in the group a fragment representing sampling points from the appropriate respective original sampling mask application, so as to preserve the correct, e.g., derivative generation result. This can be achieved by configuring the rasteriser appropriately to do this.

FIG. 10 illustrates this, and shows a 2×2 sampling (pixel) grid that should be processed as a 2×2 grouping having that configuration through the rendering process. Accordingly, when the individual sampling mask applications are divided into their appropriate fragments (patches) for rendering, each group of such fragments is configured, as shown in FIG. 10, to include in each respective position in the 2×2 fragment group a fragment corresponding to a fragment that is being used to render the corresponding sampling mask application in the 2×2 sampling mask (pixel) grid 130.

Thus, for example, as shown in FIG. 10, the first 2×2 fragment group 131 that is processed includes a first, level 0, fragment 132 corresponding to the sampling mask 133, a level 0, 16 sampling position fragment 134 corresponding to the sampling mask 135, a level 0 fragment 136 corresponding to the sampling mask 137, and a level 1 (four sampling position) fragment 138 corresponding to the sampling mask 139.

Similarly, the second 2×2 fragment group 132 to be rendered contains a level 0 fragment 140 corresponding to the sampling mask 133, a level 1 (four sampling position) fragment 141 corresponding to the sampling mask 135, a level 1 fragment 142 corresponding to the sampling mask 137, and a level 1 fragment 143 corresponding to the sampling mask 139.

As shown in FIG. 10, if centroid-mapping is not enabled, then the order of the fragments within each 2×2 fragment group can itself, however, be random.

FIG. 10 illustrates the situation where all the 2×2 sampling mask applications (pixels) in a given 2×2 sampling mask grouping are covered. However, if only one of the sampling mask applications in the 2×2 sampling mask (pixel) grid are covered, then an alternative arrangement is used in the present embodiment. This is shown in FIG. 11.

As shown in FIG. 11, in this case only one sampling mask application 150 of the 2×2 sampling mask (pixel) grid 151 is covered. In this case, that sampling mask 150 is processed as a group of 2×2 fragments 152 each representing the corresponding quadrants of the sample mask 150.

However, in order still to allow appropriate derivative generation, etc., the coverage masks and the uncovered fragments (and in particular the fragment 153 that is not covered at all in the 2×2 fragment grouping 152) are used to store the appropriate information that is needed to allow the derivatives, etc., to be derived, even though the 2×2 fragment grouping 152 only includes fragments from the same sample mask 150.

The above describes how the present embodiment may be used to carry out 4× multisampling or 16× multisampling of an image to be displayed. In use of the graphics processor of this embodiment, the application sending the image to the graphics processor for processing will indicate which form of multisampling (4× or 16×) is to be used for the image, and the graphic processor will then configure itself and operate accordingly.

It can be seen from the above that the present invention, in its preferred embodiments at least, allows 16× multisampling (anti-aliasing) to be achieved using, in essence, architecture that is configured to perform 4× multisampling (anti-aliasing). The user accordingly has the choice of selecting between ordinary 4× multisampling or having 16× multisampling, possibly with a small performance drop, but in any event faster than full 16× multisampling achieved by using 4× multisampling with 4× downsampling, and at a much lower cost than full 16× multisampling achieved by using full 16× multisampling with no downsampling.

The present invention can accordingly remove the need to increase the size of the graphics processor core to achieve 16× sampling, and therefore, for example, can allow 16× sampling to be achieved with less power usage.

The present invention can provide a power advantage over systems that use a full 16× sampled tile buffer, for example.

The present invention accordingly allows a higher rate of anti-aliasing to be achieved, but without the need for a significant increase in size and power usage of the graphics processor. Moreover, since most pixels are fully covered, any performance drop should be quite small.

This is achieved, in the preferred embodiments of the invention at least, by dividing the sampling mask into separate levels, such that if the whole sampling mask is covered it is sent to through the pipeline as a single fragment corresponding to the entire sampling mask, but if only parts of the sampling mask are covered, it may be divided into smaller patches and rendered using fragments each representing a sub-patch of the sampling mask.

1. A method of processing computer graphics for display in a graphics processing system, the method comprising:
generating and rendering graphics fragments to generate rendered graphics data for sampling points of an image to be displayed; wherein:
each graphics fragment that is rendered has associated with it a set of sampling points of the image to be displayed and is to be used to generate rendered graphics data for at least one of the sampling points of the set of sampling points associated with the fragment; and
the graphics fragments that are rendered can be associated with sets of sampling points containing different numbers of sampling points.

2. The method of claim 1, wherein the sets of sampling points that a graphics fragment can be associated with comprise: a set of sampling points for a given pixel, and a set of sampling points for a part of a pixel, of an output device the image is to be displayed on.

3. The method of claim 1, wherein the sets of sampling points that a graphics fragment can be associated with comprise: a set of 4 sampling points and a set of 16 sampling points.

4. The method of claim 1, wherein the sets of sampling points that a graphics fragment can be associated with comprise a larger set of sampling points and a smaller set of sampling points; and wherein the smaller set of sampling points that a fragment can be associated with represents a particular portion of the larger set of sampling points that a fragment can be associated with.

5. The method of claim 1, wherein the sets of sampling points that a graphics fragment can be associated comprise a set of sampling points that corresponds to all of the sampling points of a sampling mask that is to be applied to the image to be processed, and a set of sampling points that corresponds to a subset of the sampling points of the sampling mask that is to be applied to the image to be processed.

6. The method of claim 1, further comprising selecting the set of sampling points to associate with a given fragment on the basis of the coverage of a set of sampling points by a primitive being processed.

7. The method of claim 1, further comprising associating with each graphics fragment data indicating which of the sampling points in the set of sampling points that the fragment corresponds to, the fragment is being used to render.

8. The method of claim 7, wherein:
the data indicating which of the sampling points in the set of sampling points that the fragment corresponds to, the fragment is being used to render, comprises a coverage mask having a plurality of positions that can each be used to indicate whether a given sampling point or points is covered or not; and
the coverage masks that a fragment can be associated with comprise a coverage mask in which each position in the coverage mask represents a first number of sampling points, and a coverage mask in which each position in the coverage mask represents a second, different number of sampling points.

9. A method of processing graphics for display, comprising:
associating with each graphics fragment to be rendered a coverage mask for indicating the covered sampling positions the fragment is being used to render; wherein:
each such coverage mask has a plurality of positions that can each be used to indicate whether a given sampling point or points is covered or not; and
the coverage masks that a fragment can be associated with comprise a coverage mask in which each position in the coverage mask represents a first number of sampling points of the image, and a coverage mask in which each position in the coverage mask represents a second, different number of sampling points of the image.

10. A graphics processing system comprising:
rasterising and rendering circuitry for generating and rendering graphic fragments to generate rendered graphics data for sampling points of an image to be displayed; and
processing circuitry for associating with each graphics fragment that is rendered a set of sampling points of the image to be displayed, each graphics fragment to be used to generate rendered graphics data for at least one of the sampling points of the set of sampling points associated with the fragment; wherein
the graphics fragments that are rendered can be associated with sets of sampling points containing different numbers of sampling points.

11. The system of claim 10, wherein the sets of sampling points that a graphics fragment can be associated with comprise a set of sampling points for a given pixel, and a set of sampling points for a part of a pixel, of an output device the image is to be displayed on.

12. The system of claim 10, wherein the sets of sampling points that a graphics fragment can be associated with comprise a set of 4 sampling points and a set of 16 sampling points.

13. The system of claim 10, wherein the sets of sampling points that a graphics fragment can be associated with comprise a larger set of sampling points and a smaller set of sampling points; and wherein the smaller set of sampling points that a fragment can be associated with represents a particular portion of the larger set of sampling points that a fragment can be associated with.

14. The system of claim 10, wherein the sets of sampling points that a graphics fragment can be associated with comprise a set of sampling points that corresponds to all of the sampling points of a sampling mask that is to be applied to the image to be processed, and a set of sampling points that corresponds to a subset of the sampling points of the sampling mask that is to be applied to the image to be processed.

15. The system of claim 10, further comprising processing circuitry for selecting the set of sampling points to associate with a given fragment on the basis of the coverage of a set of sampling points by a primitive being processed.

16. The system of claim 10, further comprising processing circuitry for associating with each graphics fragment data indicating which of the sampling points in the set of sampling points that the fragment corresponds to, the fragment is being used to render.

17. The system of claim 16, wherein:
the data indicating which of the sampling points in the set of sampling points that the fragment corresponds to, the fragment is being used to render, comprises a coverage mask having a plurality of positions that can each be used to indicate whether a given sampling point or points is covered or not; and
the coverage masks that a fragment can be associated with comprise a coverage mask in which each position in the coverage mask represents a first number of sampling points, and a coverage mask in which each position in the coverage mask represents a second, different number of sampling points.

18. A graphics processing system comprising:
processing circuitry for associating with graphics fragments to be rendered a coverage mask for indicating the covered sampling positions each fragment is being used to render; wherein:
each such coverage mask has a plurality of positions that can each be used to indicate whether a given sampling point or points is covered or not; and
the coverage masks that a fragment can be associated with comprise a coverage mask in which each position in the coverage mask represents a first number of sampling points of the image, and a coverage mask in which each position in the coverage mask represents a second, different number of sampling points of the image.

19. A computer readable storage medium storing computer software code for performing the method of claim 1 when the software code is run on a data processor.
